(19) United States
(12) Patent Application Publication
(10) Pub. No.: US 2022/0017388 A1
(43) Pub. Date: Jan. 20, 2022

(54) APPARATUS AND METHOD FOR ENHANCED CAPACITIVE DEIONIZATION OF CONTAMINATED WATER

(71) Applicant: University of Kentucky Research Foundation, Lexington, KY (US)

(72) Inventors: Ayokunle Omosebi, Lexington, KY (US); James Landon, Lexington, KY (US); Xin Gao, Cardova, TN (US); Kunlei Liu, Lexington, KY (US)

(21) Appl. No.: 17/380,295

(22) Filed: Jul. 20, 2021

Related U.S. Application Data
(60) Provisional application No. 63/053,789, filed on Jul. 20, 2020.

(51) Int. Cl. C02F 1/469

(52) U.S. Cl. CPC C02F 1/4691; C02F 2303/16; C02F 2201/46; C02F 2201/005

(57) ABSTRACT

An apparatus and method are provided for enhanced capacitive deionization of contaminated water. The apparatus includes a contaminated water source, a capacitive deionization reactor and a flushing fluid source that is used to flush concentrated contaminants from the capacitive deionization reactor while that reactor is isolated from the contaminated water source.

### RELATED APPLICATIONS

This application claims priority to U.S. Provisional Patent Application 63/053,789, filed on Jul. 20, 2020, which is hereby incorporated by reference in its entirety.

### TECHNICAL FIELD

This document relates generally to the field of capacitive deionization and, more particularly, to a new and improved apparatus and method for enhancing the efficiency of the capacitive deionization of contaminated water.

### BACKGROUND

Capacitive deionization (CDI) technology is gaining traction as an alternative to reverse osmosis (RO), electrodialysis, and distillation, which are the incumbent technologies for water treatment. CDI is particularly attractive for treating low concentration streams, where in contrast to RO and distillation that use significant amounts of energy to separate copious water content from little impurity, CDI acts directly on the impurities instead.

CDI features a sequential stack of electrodes separated by a flow space for salt-containing fluid transport, where an electrical potential applied to the electrodes attracts ions of the opposite polarity. The use of electrical input to remove these salts offers the advantages of low-pressure operation, minimized maintenance costs, and possibly higher energy efficiency. Unlike electrodialysis, separation is facilitated by lower potentials to electro-sorb ionic salts on electrodes, and not faradaic reactions coupled with electromigration. In a CDI cell, the electrodes are cyclically polarized (charging) and depolarized (discharging) for salt removal (desalting) and concentration.

When similar volumetric flow rates or volumes of water are used in both cycles, then the water recovery, which is the ratio of treated water produced by the process to contaminated water fed into the process, is 50% at best.

This document relates to a new and improved apparatus and process for the capacitive deionization of contaminated water that utilizes fluid flushing to minimize the volume of water used in the electrode cleaning process to thereby maximize water recovery. This is done by forming the contaminate concentrate only in the water contained in CDI reactor and not with the contaminated water circulated from the contaminated water reservoir. As a result, the overall efficiency of the capacitive deionization process is greatly enhanced.

### SUMMARY

In accordance with the purposes and benefits described herein, a new and improved apparatus is provided for the capacitive deionization of contaminated water. That apparatus comprises: (a) a contaminated water source; (b) a capacitive deionization reactor downstream from the contaminated water source, the capacitive deionization reactor including a plurality of electrodes with or without ion-exchange membranes and separated by a flow space for the contaminated water (c) a voltage source connected to the plurality of electrodes, (d) a pump adapted for pumping contaminated water from the contaminated water source to the capacitive deionization reactor, (e) a flushing fluid source, (f) a first flow control valve between the pump and the capacitive deionization reactor and (g) a second flow control valve between the capacitive deionization reactor and the flushing fluid source.

In one or more of the many possible embodiments of the apparatus, the apparatus further includes a controller (a) connected to the pump, the first flow control valve, the second flow control valve, the voltage source and the flushing fluid source and (b) adapted to remove contamination from the contaminated water and discharge treated water in a first operating mode and concentrate and discharge removed contaminants in a second operating mode.

In the first operating mode the pump is activated to pump contaminated water from the contaminated water source past the first flow control valve to the capacitive deionization reactor. Further, a voltage potential is applied across the plurality of electrodes to polarize the plurality of electrodes. As a result, contamination/salt from the contaminated water is electro-sorbed onto the plurality of electrodes and treated water is discharged from the capacitive deionization reactor past the second flow control valve where it may be collected for further processing or use.

In the second operating mode, the capacitive deionization reactor is isolated from the contaminated water source and the plurality of electrodes are depolarized to release previously removed and electro-sorbed contaminants/salts into a concentrated contaminated water volume isolated from the contaminated water source. Fluid from the flushing fluid source then flushes the concentrated contaminated water volume for discharge from the capacitive deionization reactor. This use of flushing fluid (e.g. inert gas, air or a liquid other than the contaminated water to be processed) conserves the contaminated water exclusively for processing and conversion to treated water thereby greatly increasing the efficiency of the capacitive deionization process.

In one or more of the many possible embodiments of the apparatus, the first flow control valve is a three-way valve having a first port in communication with the pump and the contaminated water source, a second port in communication with the capacitive deionization reactor and a third port adapted for discharge of the concentrated contaminated water volume.

In one or more of the many possible embodiments of the apparatus, the second flow control valve is a three-way valve having a first port in communication with the capacitive deionization reactor, a second port in communication with the flushing fluid source and a third port adapted for discharge of the treated water.

In accordance with an additional aspect of the invention, a new and improved method is provided for enhanced treated water recovery by capacitive deionization. That method comprises the steps of: (a) delivering contaminated water to a capacitive deionization reactor, (b) electro-sorbing contamination from the contaminated water onto a plurality of electrodes in the capacitive deionization reactor by polarizing the plurality of electrodes, (c) discharging treated water from the capacitive deionization reactor, (d) isolating a volume of contaminated water in the capacitive deionization reactor from any source of contaminated water, (e) releasing the previously electro-sorbed contamination from the plurality of electrodes into the isolated volume of contaminated water to produce a concentrated contaminated water volume by depolarizing the plurality of electrodes and (f) discharging the concentrated contaminated water volume from the capacitive deionization reactor by flushing the capacitive deionization reactor with flushing fluid. For the purposes of this document, the term ‘depolarizing’ means (a) the removal of polarization, (b) the reversing of the applied voltage or (c) the reducing of the applied voltage.

The step of delivering contaminated water to the capacitive deionization reactor may include the step of pumping water from a contaminated water source through a first flow control valve to the capacitive deionization reactor.

The step of discharging the treated water from the capacitive deionization reactor may include the step of passing the treated water through a second flow control valve downstream from the capacitive deionization reactor.

The step of discharging the concentrated contaminated water volume from the capacitive deionization reactor may include delivering flushing fluid through the second flow control valve to the capacitive deionization reactor and flushing the concentrated contaminated water volume through a port in the first flow control valve adapted to discharge the concentrated contaminated water volume.

In accordance with yet another aspect, a method of enhancing water recovery by capacitive deionization, comprises: (a) in a first mode of operation, delivering contaminated water from a contaminated water source to a capacitive deionization reactor, electro-sorbing contamination from the contaminated water onto a plurality of electrodes in the capacitive deionization reactor by polarizing the plurality of electrodes, and discharging treated water and (b) in a second mode of operation, isolating the capacitive deionization reactor from the contaminated water source, releasing the previously electro-sorbed contamination from the plurality of electrodes into a volume of contaminated water isolated in the capacitive deionization reactor to produce a concentrated contaminated water volume by depolarizing the plurality of electrodes and discharging the concentrated contaminated water volume from the capacitive deionization reactor by flushing the capacitive deionization reactor with flushing fluid.

That method may further include the step of only circulating contaminated water through the capacitive deionization reactor when in the first mode of operation and not in the second mode of operation. Further, that method may include the step of only circulating flushing fluid through the capacitive deionization reactor during discharge of the concentrated contaminated water volume from the capacitive deionization reactor. Flushing fluid refers to an inert gas, air or a liquid other than the contaminated water to be processed.

In the following description, there are shown and described several preferred embodiments of the new and improved apparatus and method for enhanced treated water recovery by capacitive deionization. As it should be realized, the apparatus and method are capable of other, different embodiments and their several details are capable of modification in various, obvious aspects all without departing from the apparatus and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and related method for enhanced capacitive deionization of contaminated water and together with the description serve to explain certain principles thereof.

FIG. 1 is a schematic block diagram of the new and improved apparatus for capacitive deionization of contaminated water.

FIGS. 2A and 2B are detailed schematic illustrations of one possible configuration for the plurality of electrodes in the capacitive deionization reactor of the apparatus of FIG. 1 with or without the optional plurality of ion-exchange membranes. FIG. 2A illustrates the first or decontamination operating mode wherein polarized electrodes electro-sorb contaminants from the contaminated water. FIG. 2B illustrates the second or electrode cleaning mode wherein the electrodes are deployed to release contaminants previously electro-sorbed onto the electrodes during the first or decontamination operating mode.

FIGS. 3a-3c illustrate operation of the apparatus of FIG. 1. More particularly, FIG. 3a shows operation of the apparatus in a first mode wherein contamination is electro-sorbed onto the plurality of polarized electrodes in the capacitive deionization reactor. FIG. 3b shows initial operation of the apparatus in the second mode wherein the capacitive deionization reactor is isolated from the contaminated water source and the electrodes are depolarized to release the previously electro-sorbed contamination. FIG. 3c shows the final operation of the apparatus in the second mode wherein the concentrated contaminated water volume in the capacitive deionization reactor is flushed from the reactor using flushing fluid from the flushing fluid source.

FIG. 4 is a graphical illustration of enhanced water recovery (WR) from a CDI unit using volumes of 300, 400 and 500 mL of starting solution. The CDI unit was charged at 1.2 V.

FIG. 5 is a graphical illustration of the voltage, current and conductivity profile during 0.4/−0.4 V i-CDI operation with and without air flushing in the concentration step.

FIG. 6 is a graphical illustration of zoomed-in conductivity profiles and salt adsorption capacity for i-CDI operation with and without air flushing Without flushing, the cell influent is desalinated and concentrated at the same flow rate, while with flushing, concentration is at no flow (A), followed by air flush for 0.03 hr (B), then desalination (C).

Reference will now be made in detail to the present preferred embodiments of the apparatus and method, examples of which are illustrated in the accompanying drawing figures.

### DETAILED DESCRIPTION

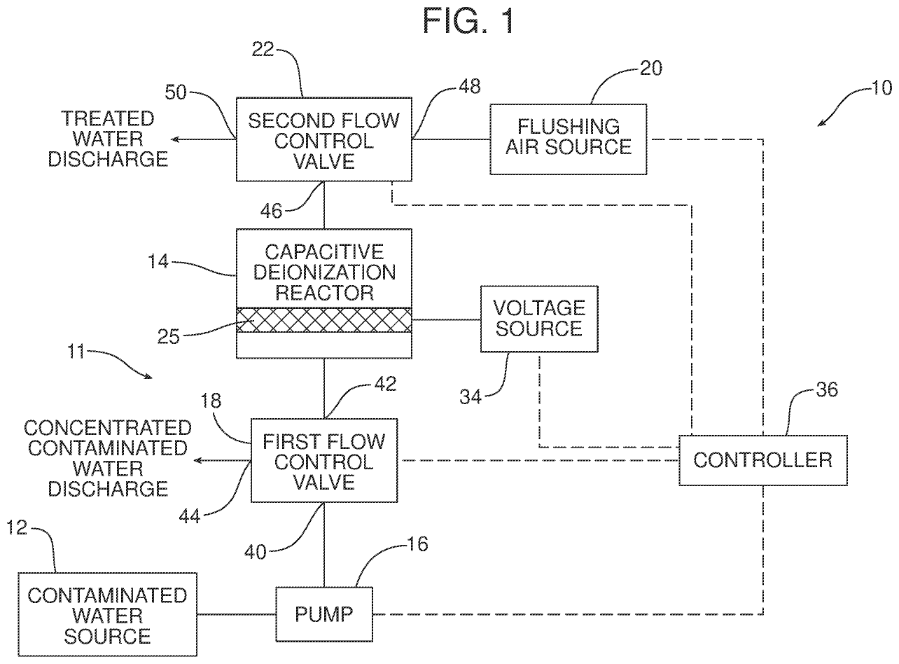

Reference is now made to FIG. 1 which schematically illustrates the apparatus 10 for capacitive deionization of contaminated water. The apparatus 10 includes a flow circuit 11 having a contaminated water source 12, a capacitive deionization reactor 14 downstream from the contaminated water source and a pump 16 adapted for pumping contaminated water from the contaminated water source to the capacitive deionization reactor. A first flow control valve 18 is provided between the pump 16 and the capacitive deionization reactor 14. The apparatus 10 also includes a flushing fluid source 20. A second flow control valve 22 is provided between the capacitive deionization reactor 14 and the flushing fluid source 20.

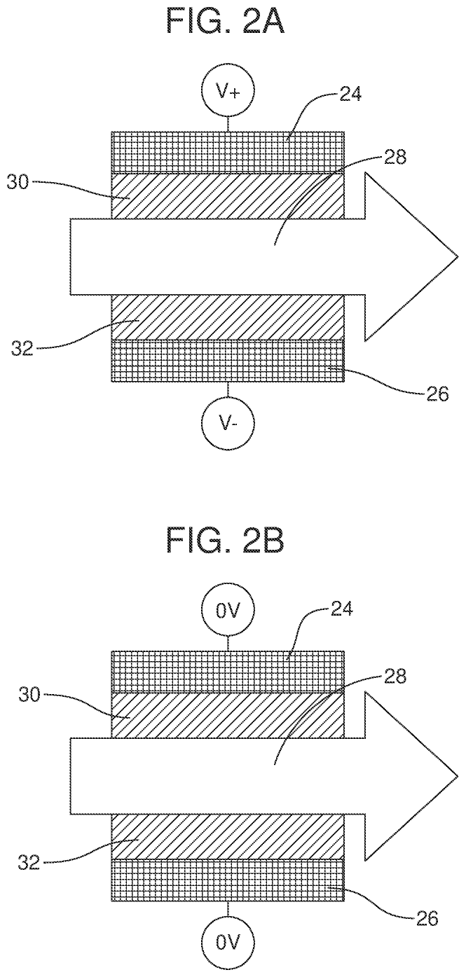

As illustrated in FIGS. 1, 2A and 2B, an electrode assembly 25 provided in the capacitive deionization reactor 14 includes a plurality of electrodes 24 (anode), 26 (cathode). A flow space 28, for contaminated water is provided between the plurality of electrodes. As is known in the art and explained in greater detail below, in a first mode of operation (see FIG. 2A and note the action arrow in flow space 28 representing the flow of contaminated water), the plurality of electrodes 24, 26 are polarized to electro-sorb contamination onto the electrodes from the contaminated water flowing through the flow space 28. In a second mode of operation (see FIG. 2B and note the action arrow in the flow space 28 representing the flow of contaminated water and flushing air), the plurality of electrodes 24, 26 are depolarized to release the previously electro-sorbed contamination from the electrodes.

As further illustrated in FIGS. 2A and 2B, the plurality of electrodes 24, 26 may also include a plurality of ion-exchange membranes 30, 32 associated with the plurality of electrodes. The optional ion-exchange membranes 30, 32 include an anion exchange membrane 30 and a cation exchange membrane 32 of a type known in the art to be useful in and enhance the capacitive deionization of contaminated water.

A voltage source 34 is connected to the plurality of electrodes 24, 26. That voltage source 34 is adapted to apply a voltage potential across the electrodes 24, 26 in order to electro-sorb the contamination from the contaminated water onto the electrodes.

As further illustrated in FIG. 1, the apparatus 10 may also include a controller 36 that is operatively connected to the pump 16, the first flow control valve 18, the second flow control valve 22, the voltage source 34 and the flushing fluid source 20. The controller 36 is adapted to control the operation of the apparatus 10, including the pump 16, the first control valve 18, the second control valve 22, the voltage source 34 and the flushing fluid source 20. The controller 36 may comprise a dedicated microprocessor, a computing device or an electronic control unit (ECU) of a type known in the art that operates in accordance with instructions from appropriate control software.

In the illustrated embodiment, the first flow control valve 18 is a three-way valve having a first port 40 in communication with the pump 16, a second port 42 in communication with the capacitive deionization reactor 14 and a third port 44 adapted for discharge of the concentrated contaminated water volume flushed from the capacitive deionization reactor. The second flow control valve 22 is also a three-way valve having a first port 46 in communication with the capacitive deionization reactor 14, a second port 48 in communication with the flushing fluid source 20 and a third port 50 adapted for discharge of the treated water received from the capacitive deionization reactor. Of course, other valve arrangements could be utilized if desired.

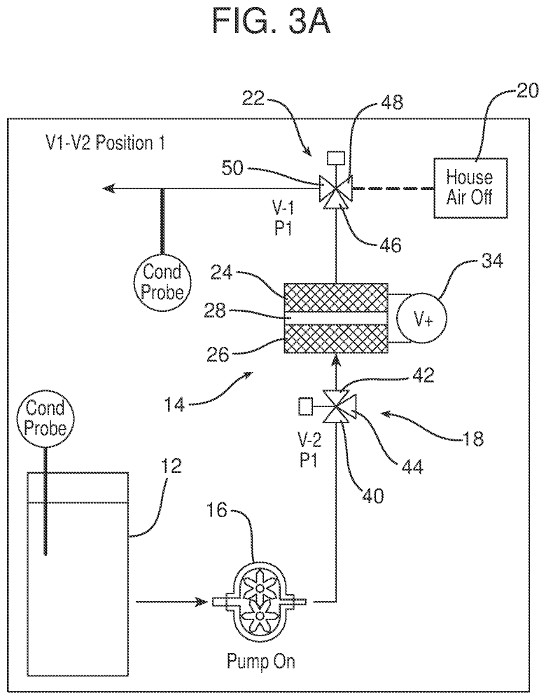

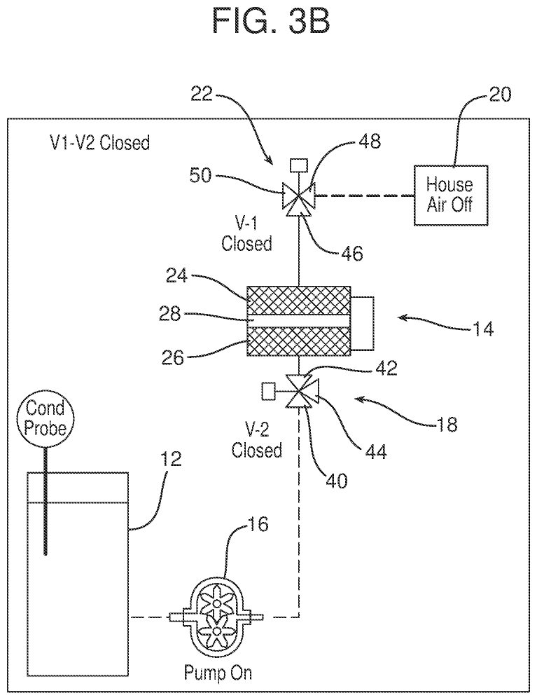

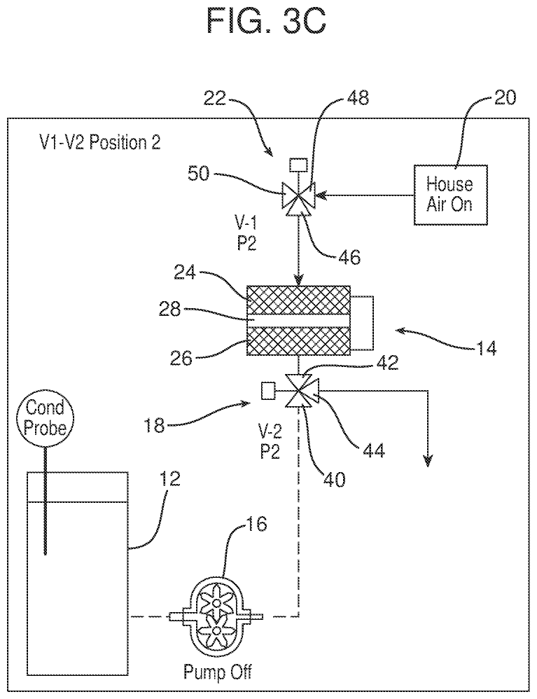

In a first operating mode illustrated in FIG. 3A, the controller 34 is adapted to remove contamination from the contaminated water in the capacitive deionization reactor 14 and discharge treated water. In a second operating mode, illustrated in FIGS. 3B and 3C, the controller 36 is adapted to concentrate the contaminants in the capacitive deionization reactor 14 and discharge the concentrated contaminants from the capacitive deionization reactor.

More specifically, the apparatus 10 is useful in a method for enhanced treated water recovery by means of capacitive deionization. As best illustrated in FIG. 3A, that method includes the step of delivering contaminated water from the contaminated water source 12 to the capacitive deionization reactor 14 by means of the pump 16 pumping the contaminated water through the first flow control valve 18. As the contaminated water moves through the capacitive deionization reactor 14 it passes through the flow space 28 between the plurality of electrodes 24, 26. During this time, the voltage source 34 is activated to polarize the electrodes 24, 26 resulting in the electro-sorbing of contamination from the contaminated water onto the electrodes. The relatively contamination-free, treated water is then forced by the pump 16 from the capacitive deionization reactor 14 through the second control valve 22 with the treated water being discharged from the third port 50 where it may be collected for further processing or use. Thus, it should be appreciated that the first operating mode illustrated in FIG. 3A includes the steps of delivering contaminated water from the contaminated water source 12 to a capacitive deionization reactor 14, electro-sorbing contamination from the contaminated water onto the plurality of electrodes 24, 26 in the capacitive deionization reactor by polarizing the plurality of electrodes, and discharging the treated water.

As best illustrated in FIG. 3B, the method also includes the steps of: (a) isolating a volume of contaminated water in the capacitive deionization reactor 14 from the contaminated water source and (b) releasing the previously electro-sorbed contamination from the plurality of electrodes into the isolated contaminated water volume to produce a concentrated contaminated water volume.

More particularly, the isolation step is completed when the controller 36 (a) deactivates the pump 16, (b) directs the second flow control valve 22 to close the first port 46 in communication with the capacitive deionization reactor 14 and the third port 50 for discharge of the treated water and (c) directs the first flow control valve 18 to close both the first port 40 in communication with the pump and the third port 44 for discharge of the concentrated contaminated water. The depolarizing of the electrodes 24, 26 may be done by shorting the electrodes in response to a control signal from the controller 36. This completes the first stage of the second operating mode.

The second stage of the second operating mode is illustrated in FIG. 3C. This includes the discharging of the concentrated contaminated water from the capacitive deionization reactor 14. More particularly, the controller 36 (a) directs the second control valve 22 to open both the second port 48 in communication with the flushing fluid supply 20 and the first port 46 in communication with the capacitive deionization reactor 14, (b) directs the first flow control valve 18 to open the third port 44 for discharge of the concentrated contaminated water volume and (c) activates the flushing fluid source 20 to force flushing fluid into and through the capacitive deionization reactor which, in turn, flushes the concentrated contaminated water volume from the reactor through the third port for collection and further processing. Fluid useful for this purpose includes inert gas, air, and a liquid other than the contaminated water to be treated.

Here it should be noted that during the first mode of operation, only contaminated water is delivered from the contaminated water supply 12 to the capacitive deionization reactor 14 for decontamination while during the second operating phase, only flushing fluid is delivered from the flushing fluid source 20 to the reactor. No contaminated water is delivered to the capacitive deionization reactor 14 during the second operating phase and no flushing fluid is delivered to the reactor during the first operating phase. This results in a greater percentage of the contaminated water undergoing decontamination and being converted to treated water, thereby greatly enhancing processing efficiency.

### EXPERIMENTAL SECTION

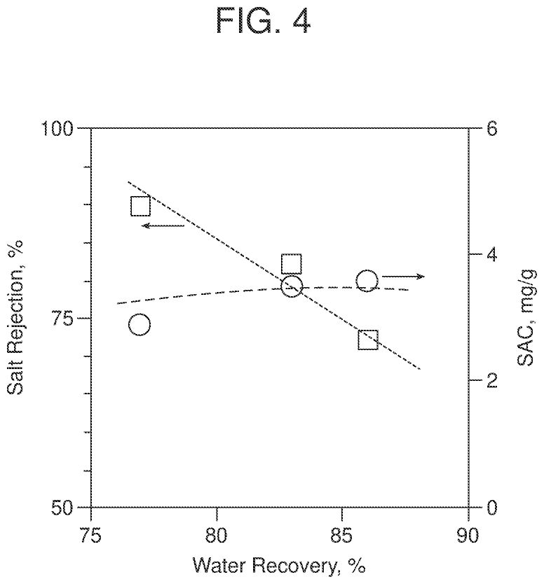

In order to demonstrate the air flushing CDI, tests were first executed in a flow-by system with a total of 4 g Kynol carbon electrodes. During testing, diluted wet flue gas desulfurization WFGD water to simulate 30 mg L⁻¹ zeolite dewatering (ZDW) permeate (˜60 μS cm⁻¹) was continuously circulated through the CDI unit at 25 mL min⁻¹. Charge and discharge were facilitated with a Tektronix power supply, and current and conductivity data were correspondingly logged. The salt adsorption capacity (SAC) in mg (of equivalent NaCl) g⁻¹ (of carbon) was calculated from the change in salt concentration (mg L⁻¹) multiplied by the volume normalized by 4 g of carbon. The salt rejection (SR) is defined as (1−c_{final}/cᵢₙᵢₜᵢₐₗ)×100, where cᵢₙᵢₜᵢₐₗ is the salt concentration before treatment, and c_{final} is the salt concentration after treatment. The three-step procedure in FIGS. 3A-3C is used to enhance water recovery. In the first step, the pump 16 recirculates the test solution from the reservoir 12 via the unit 14 and back to the reservoir, while the potential is applied to the unit. After the electrodes 24, 26 are saturated (meaning that the max SAC value is attained), in FIG. 3B, the electrodes are shorted, the pump 16 is switched off, and valves 18 and 22 are closed, allowing for discharge into the unit's internal volume and tubing between valves. In step 3, valves 18 and 22 are set to position 2, and house air is used for flushing the concentrated solution into a tank. Steps 1-3 took about 2 hours, and the flushed volume is about 70 mL FIG. 4 shows the effect of WR on SR and SAC by changing the volume of the starting solution in the reservoir. It can be seen that SAC stays relatively constant between 2.9 and 3.5 mg (of equivalent NaCl) g⁻¹ (of carbon), while SR marginally decreases with increasing WR due to the fixed capacity of the electrodes for this particular experimental design. Discharge using the conventional scheme with flushing of concentrated contaminants using water from the contaminated water supply, will lead to lower water recoveries because the concentrate/discharge volume >70 mL.

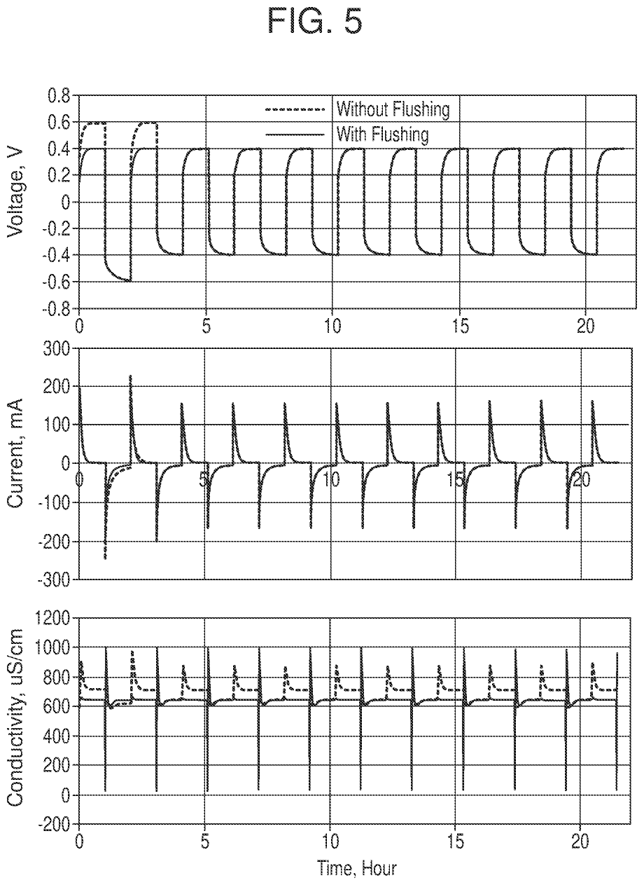

In order to demonstrate repeatability and stability, the air-assisted flushing method is applied to CDI cells with inverted characteristics and compared to a system without flushing. Inverted CDI cells use cleverly selected voltage windows, sometimes reversed, to leverage chemical surface charge on the electrodes, and mitigate electrode degradation. Testing was executed in a flow-by batch-mode system with ˜4.2 g Kynol carbon electrodes. During testing, 1 L of −700 μS/cm sodium chloride solution was continuously circulated through the cell at 25 mL min⁻¹. The voltage, current, and conductivity responses are shown in FIG. 5 for cells with and without flushing. When the cell was operated without flushing, it was electronically charged-concentrated at 0.4 or 0.6 V and electronically discharged-desalinated at −0.4 or −0.6 V for 1 hour, each with 25 mL/min solution circulation. When air-assisted flushing was used, there was no flow during concentration at +0.4 V for 1 hour, followed by air flush (10 psig) for 0.03 hr, then desalination at −0.4 V for 1 hour with 25 mL/min solution circulation. Without flushing, the water recovery (WR) was 50%, while with flushing 80%+ WR was realized, and potentially higher WR can be assessed by reducing the internal volume of the cell.

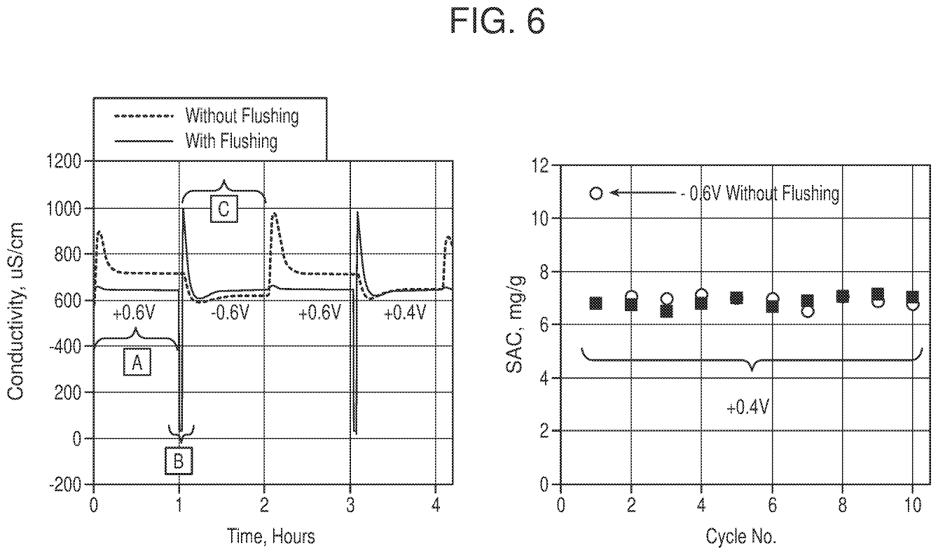

FIG. 5 shows matching voltage, current profiles except during 0.6/−0.6 V operation, and a zoomed-in conductivity profile (FIG. 6) show more clearly that the desalination profiles also match at similar voltages except with the expected more considerable conductivity drop for the larger −0.6 V operation. FIG. 6 also shows a very stable performance for both cells independent of flushing. While longer time scales are used for demonstration purposes here, for continuous operation, the charging and discharging times are shorter, but the already minor flushing time (0.03 hours) will not impact process operation.

Capacitive deionization is suitable as a polishing step for water containing ionized content <10,000 ppm, e.g., inorganic, toxic or, organic, and air flushing capacitive deionization is an improvement that can be employed for all CDI applications, to reduce the volume of waste to be stored, transported or further treated. Examples of potential uses for the technology are given below. Water treatment for the utility sector—following increased regulations by the US EPA, power generation plants are considering technologies for zero liquid discharge and
i. reducing dependence on freshwater withdrawal from rivers and lakes. Air flush CDI can be used to (1) polish service water, ˜300 ppm to more beneficial water for boiler application, and (2) selectively treat and recover copper from turbine blowdown.
ii. Water treatment for agricultural sector/reuse—the air flush CDI can be used for nutrient control, i.e., nitrate concentration for irrigation.
iii. Water pretreatment for membrane technologies—polymeric membrane technologies, including reverse osmosis and nanofiltration, are particularly susceptible to fouling by organic matter due to polymer-polymer interactions. The air flushed CDI can be used as a pretreatment step to remove NTU and charged organic matter to extend the life of the membranes.

The foregoing has been presented for purposes of illustration and description. It is not intended to be exhaustive or to limit the embodiments to the precise form disclosed. Obvious modifications and variations are possible in light of the above teachings. For example, any embodiment of the apparatus may include only the electrodes 24, 26 alone or the electrodes 24, 26 in combination with the cooperating ion-exchange membranes 30, 32 of a type known in the art. It is also possible to operate in a rocking chair CDI desalination mode where an ion-exchange membrane is used to divide the flow space 28 in two, and polarization simultaneously generates concentrate and treated water in the same cycle. All such modifications and variations are within the scope of the appended claims when interpreted in accordance with the breadth to which they are fairly, legally and equitably entitled.

What is claimed:

1. An apparatus for capacitive deionization of contaminated water, comprising:
a contaminated water source;
a capacitive deionization reactor downstream from the contaminated water source, the capacitive deionization reactor including a plurality of electrodes separated by a flow space for the contaminated water;
a voltage source connected to the plurality of electrodes;
a pump adapted for pumping contaminated water from the contaminated water source to the capacitive deionization reactor;
a flushing fluid source;
a first flow control valve between the pump and the capacitive deionization reactor; and
a second flow control valve between the capacitive deionization reactor and the flushing fluid source.

2. The apparatus of claim 1, further including a controller (a) connected to the pump, the first flow control valve, the second flow control valve, the voltage source and the flushing fluid source and (b) adapted to remove contamination from the contaminated water and discharge treated water in a first operating mode and concentrate and discharge removed contaminants in a second operating mode.

3. The apparatus of claim 2, wherein in the first operating mode the pump is activated to pump contaminated water from the contaminated water source past the first flow control valve to the capacitive deionization reactor.

4. The apparatus of claim 3, wherein in the first operating mode, a voltage potential is applied across the plurality of electrodes so as to polarize the plurality of electrodes and contamination from the contaminated water is electro-sorbed onto the plurality of electrodes and treated water is discharged from the capacitive deionization reactor past the second flow control valve.

5. The apparatus of claim 4, wherein in the second operating mode, the capacitive deionization reactor is isolated from the contaminated water source and the plurality of electrodes are depolarized to release previously removed and electro-sorbed contaminants into a concentrated contaminated water volume in the capacitive deionization reactor isolated from the contaminated water source.

6. The apparatus of claim 5, wherein in the second operating mode, flushing fluid from the flushing fluid source flushes the concentrated contaminated water volume from the capacitive deionization reactor.

7. The apparatus of claim 6, wherein the first flow control valve is a three-way valve having a first port in communication with the pump and the contaminated water source, a second port in communication with the capacitive deionization reactor and a third port adapted for discharge of the concentrated contaminated water volume.

8. The apparatus of claim 7, wherein the second flow control valve is a three-way valve having a first port in communication with the capacitive deionization reactor, a second port in communication with the flushing fluid source and a third port adapted for discharge of the treated water.

9. The apparatus of claim 8, further including at least one ion-exchange membrane in the capacitive deionization reactor adapted to further enhance separation of contamination from the contaminated water.

10. The apparatus of claim 6, further including at least one ion-exchange membrane in the capacitive deionization reactor adapted to further enhance separation of contamination from the contaminated water.

11. The apparatus of claim 1, further including at least one ion-exchange membrane in the capacitive deionization reactor adapted to further enhance separation of contamination from the contaminated water.

12. A method for enhanced treated water recovery by capacitive deionization, comprising:
delivering contaminated water to a capacitive deionization reactor;
electro-sorbing contamination from the contaminated water onto a plurality of electrodes in the capacitive deionization reactor by polarizing the plurality of electrodes;
discharging the treated water from the capacitive deionization reactor;
isolating a volume of contaminated water in the capacitive deionization reactor from the contaminated water source;
releasing the previously electro-sorbed contamination from the plurality of electrodes into the isolated volume of contaminated water to produce a concentrated contaminated water volume by depolarizing the plurality of electrodes; and
discharging the concentrated contaminated water volume from the capacitive deionization reactor by flushing the capacitive deionization reactor with flushing fluid.

13. The method of claim 12, wherein the delivering of contaminated water to the capacitive deionization reactor includes the step of pumping water from a contaminated water source through a first flow control valve to the capacitive deionization reactor.

14. The method of claim 13, wherein the discharging of the treated water from the capacitive deionization reactor includes passing the treated water through a second flow control valve downstream from the capacitive deionization reactor.

15. The method of claim 14, wherein the discharging of the concentrated contaminated water volume from the capacitive deionization reactor includes delivering the flushing fluid through the second flow control valve to the capacitive deionization reactor and flushing the concentrated contaminated water volume through a port in the first flow control valve adapted to discharge the concentrated contaminated water volume.

16. A method of enhancing treated water recovery by capacitive deionization, comprising:
in a first mode of operation, delivering contaminated water from a contaminated water source to a capacitive deionization reactor, electro-sorbing contamination from the contaminated water onto a plurality of electrodes in the capacitive deionization reactor by polarizing the plurality of electrodes, and discharging the treated water; and
in a second mode of operation, isolating the capacitive deionization reactor from the contaminated water source, releasing the previously electro-sorbed contamination from the plurality of electrodes into a volume of contaminated water isolated in the capacitive deionization reactor to produce a concentrated contaminated water volume by depolarizing the plurality of electrodes and discharging the concentrated contaminated water volume from the capacitive deionization reactor by flushing the capacitive deionization reactor with flushing fluid.

17. The method of claim 16, including only circulating contaminated water through the capacitive deionization reactor when in the first mode of operation and not in the second mode of operation.

18. The method of claim 17, including only circulating flushing fluid through the capacitive deionization reactor during discharge of the concentrated contaminated water volume from the capacitive deionization reactor.

19. The method of claim 16, including only circulating flushing fluid through the capacitive deionization reactor during discharge of the concentrated contaminated water volume from the capacitive deionization reactor wherein that flushing fluid is selected from a group consisting of an inert gas, air and a liquid other than the contaminated water to be treated.
